(19) United States
(12) Patent Application Publication
(10) Pub. No.: US 2012/0205207 A1
(43) Pub. Date: Aug. 16, 2012

(54) High Torque Damper with Variable Speed Control

(75) Inventors: Randy L. Gaigler, Parkville, MD (US); Philip Greenwald, York, PA (US)

(73) Assignee: LOCKHEED MARTIN CORPORATION, Bethesda, MD (US)

(21) Appl. No.: 13/028,483

(22) Filed: Feb. 16, 2011

(51) Int. Cl. F16F 9/52; F16F 9/14

(52) U.S. Cl. 188/276

(57) ABSTRACT

A damper is disclosed for damping the rotational speed of an article that is coupled to, and rotates about the longitudinal axis of, the damper. The illustrative damper comprises: a thermal compensator that, in response to the ambient temperature, linearly expands and contracts; a blade that defines a first chamber and a second chamber within the damper; an orifice between the first chamber and the second chamber, wherein the orifice is operatively coupled to the thermal compensator such that the orifice (i) decreases when the thermal compensator expands and (ii) increases when the thermal compensator contracts; and a fluid that fills the first chamber and the second chamber, wherein the fluid flows through the orifice when the blade rotates about a longitudinal axis of the apparatus, and wherein the rate of flow of the fluid depends on the size of the orifice. The rotational speed available from the damper depends at least in part on the rate of flow of the fluid through the orifice.

### STATEMENT REGARDING FEDERALLY-SPONSORED RESEARCH

This invention was made with U.S. Government support under Contract Number N00014-05-9-0001 awarded by the Office of Naval Research. The Government has certain rights in the invention.

### FIELD OF THE INVENTION

The present invention relates to damping devices for controlling and adjusting rotational speed.

### BACKGROUND OF THE INVENTION

The Expeditionary Warfare Craft Sea Lifter (hereinafter “E-Craft”) is a demonstration project for a new-generation beachable high-speed vessel. The E-Craft is a multi-purpose cargo and troop ship that performs in diverse environments and circumstances, such as at high speed, in ice, in shallow waters, and in beaching, loading, unloading, and rescue operations.

FIG. 1 depicts an illustration of E-Craft 100. The E-Craft comprises ramp 102, which is used for loading, unloading, rescue and various other operations involving a ramp. Ramp 102 is a folding ramp; FIG. 2 depicts ramp 102 unfolding at a shoreline.

As depicted in FIG. 2, ramp 102 comprises several component panels or stages that are rotatably coupled to one another. In the illustrative embodiment, ramp 102 includes three such panels: stage 202, stage 204, and apron 206. Apron 206 is the last of the three panels and is unconstrained at one end. The other end of apron 206 is rotatably coupled to its predecessor stage, stage 204. In operation, apron 206 freely rotates over about 180 degrees to open to a deployed position from a folded position, as illustrated in the bottom image of FIG. 2.

One of the problems with conventional ramp 102 arises from the fact that the center of mass of apron 206 is significantly offset from the rotational coupling that couples stage 204 to apron 206. This offset creates a substantial gravitational component to the apron's rotation, causing the apron to slam to the ground in the absence of some type of intervention or resistive force. Uncontrolled rotation can damage the apron, thereby increasing the costs of maintenance and ownership of the ramp.

One way that such uncontrolled rotation has been addressed is to use a friction-based coupling (not shown) that slows the apron's rotational speed. Although effective, friction-based couplings are subject to substantial wear-and-tear. Moreover, such a coupling is relatively susceptible to jamming and its effectiveness is readily compromised by environmental factors. Using a friction-based coupling thus results in a ramp having relatively high maintenance requirements and decreased versatility.

### SUMMARY OF THE INVENTION

The inventors of the present invention recognized the need for a ramp that:
is suitable for the diverse environmental, climate, and operational conditions envisioned for the E-craft;
has reduced maintenance needs, which is particularly advantageous since the E-craft is likely to be deployed in environments/situations that make maintenance impractical for extended periods; and
is safe for use by civilians or others who are unfamiliar with its operation.

The illustrative embodiment of the present invention is a ramp comprising a high-torque damper with variable speed control (hereinafter “damper”). In the illustrative embodiment, the damper couples to an apron that is at the end of a ramp. The damper has a large range of motion and controls the speed of rotation of the apron. In effect, the damper according to the illustrative embodiment acts as a rotational axle between the apron and the predecessor stage of the ramp. The present invention is not limited to aprons and ramps, however. For example, the damper described herein can be used to provide an improved tailgate, wherein the damper controls the tailgate's rotational speed when it is to be opened for loading cargo into the rear of a vehicle.

According to the illustrative embodiment, the damper comprises a cylindrical housing and a shaft that runs through the housing along the longitudinal axis thereof. Inside the housing, the shaft has an affixed blade that separates the housing's interior into two chambers. The two chambers are fluidically connected by an orifice. The chambers are filled with a fluid and the housing is sealed to contain the fluid. The shaft continues outside the housing, wherein it operatively couples to the apron (or to another rotating structure). When the apron rotates, it causes the shaft to rotate, which in turn rotates the blade. As it rotates, the blade pushes on the fluid in one of the chambers and creates a flow through the orifice to the other chamber.

The rate of flow through the housing's interior is determined by (1) the rheological properties (e.g., viscosity, etc.) of the fluid and (2) the size of the orifice. In regards to the rheological properties, as the viscosity of the fluid decreases, resistance to flow decreases and the viscous drag on an object immersed in the fluid decreases; as the viscosity of the fluid increases, the resistance to flow increases and the viscous drag on an object immersed in the fluid increases. For an orifice of a given size, increased viscosity results in a reduced rate of flow of the fluid and a reduction in the speed at which the blade (see above) moves through the fluid. Thus, an increase in viscosity slows the shaft's rotational speed. In regards to the size of the orifice, a smaller orifice increases the drag upon the flow of fluid, thereby slowing the shaft's rotational speed. Conversely, a larger orifice decreases drag and enables the shaft to rotate faster. In this way, viscosity and orifice size affect the speed of rotation of the apron or of any structure that is operatively coupled to the damper.

According to the illustrative embodiment, the orifice size is changeable. The size of the orifice is changed via the operation of a thermal compensation device (hereinafter “thermal compensator”). As a consequence of its structure and/or material composition, the thermal compensator expands and/or contracts in response to changes in ambient temperature. The thermal compensator is arranged with respect to the orifice such that the expansion or contraction of the thermal compensator changes an amount by which the orifice is obstructed, thereby affecting its cross-sectional area for fluid flow. In the illustrative embodiment:
(i) the thermal compensator is designed so that as the ambient temperature increases, the thermal compensator elongates;
(ii) the damper is configured such that when the thermal compensator elongates, the orifice size (i.e., cross-sectional area for flow through the orifice) decreases; and
(iii) the fluid that flows through the orifice between the chambers is selected such that its viscosity decreases with an increase in temperature.
   Ordinarily, an increase in ambient temperature (and, hence, in the temperature of the fluid in the chambers) results in an increase in flow through the orifice. This ultimately results in an increase in the rotational speed of the apron. But in the illustrative embodiment, when temperature increases, the elongating thermal compensator will decrease the size of the orifice and thus reduce the rate of flow of the fluid. With an appropriately designed thermal compensator (i.e., accounting for the rheological characteristics of the fluid), the increase in drag resulting from the decrease in orifice size offsets (to some degree) the decrease in drag due to the decrease in viscosity. The result is that the flow rate through the orifice changes less than it otherwise would. Thus, because of the thermal compensator, the rotational speed available from the damper remains relatively unchanged, i.e., substantially constant, over the design temperature range, or at least, exhibits less change than it would in the absence of the thermal compensator.

In some embodiments, orifice size is adjusted not only by the thermally-triggered elongation/contraction of the thermal compensator, but also by altering the position of the thermal compensator with respect to the orifice. Specifically, in some embodiments, a position-adjustment mechanism (hereinafter “position adjustor”) moves the thermal compensator relatively closer to or further from the orifice. The amount of the orifice that is obstructed (i.e., the resulting size of the orifice) is therefore a function of the temperature-dictated length of the thermal compensator as well as its position with respect to the orifice.

In the illustrative embodiment, the position adjustor is a screw that is coupled to the thermal compensator. Turning the screw in one or the other direction (i.e., clockwise or counterclockwise) causes the screw and the thermal compensator to advance or retract relative to the orifice. The position adjustor thus provides a way to calibrate, fine tune, or alter the operation of the thermal compensator. For a theoretically perfect thermal compensator, thermal response of the device is precisely matched to the fluid's viscosity-temperature behavior over the design temperature range such that the resulting change in orifice size maintains a constant rotational speed available from the damper. As such, once a perfect thermal compensator is suitably positioned with respect to the orifice, it need not be moved as long as the temperature remains within the design range. But a “real” thermal compensator is not perfect, and changes in the length of the thermal compensator with temperature will not perfectly correct for changes in fluid viscosity. To maintain a near constant rotational speed for the apron as temperature changes, the position of the thermal compensator may require slight adjustments to alter the amount by which the orifice is occluded. This is accomplished by the position adjustor. Thus, the position adjustor enables an operator to fine tune the damper's temperature response for nonlinearities in the thermal compensator's response or for operational temperatures that are out of the design temperature range. Alternatively, by using the position adjustor, an operator can increase or decrease the rotational speed available from the damper from the nominal speed.

In some embodiments, this position adjustment of the thermal compensator is performed in “trial-and-error” fashion. That is, an operator makes a change in the position of the thermal compensator using the position adjustor and then observes the resulting change in the rotational speed of the apron. In alternative embodiments, the operation of the position adjustor is automated and a control loop is established to provide “automatic fine tuning.”

Collectively, the thermal compensator and the position adjustor expand the operational window and versatility of the damper.

It should be noted that the damper according to the present invention is distinguishable from a dashpot. A dashpot or shock absorber generally lacks adjustability and thermal compensation. Further, dashpots often comprise springs that dissipate mechanical energy, but no spring is necessary to embodying the present invention.

According to some illustrative embodiments, the damper is an apparatus comprising: a thermal compensator that, in response to a change in the ambient temperature, one of expands and contracts; a blade that defines a first chamber and a second chamber within a housing of the damper; an orifice between the first chamber and the second chamber, wherein the orifice is operatively coupled to the thermal compensator such that the orifice (i) decreases when the thermal compensator expands and (ii) increases when the thermal compensator contracts; and a fluid that fills the first chamber and the second chamber, wherein the fluid flows through the orifice when the blade rotates about a longitudinal axis of the apparatus, and wherein the rate of flow of the fluid depends on the size of the orifice.

According to some embodiments, a method is disclosed comprising: operatively coupling an article to a housing that contains a fluid, wherein a rotational speed of the article is controlled by a flow of the fluid within the housing, and wherein the rate of flow of the fluid depends on the size of an orifice within the housing; positioning a thermal compensator with respect to the orifice such that a change in length of the thermal compensator changes the size of the orifice, wherein the change in length is in response to a change in the ambient temperature; and rotating the article, thereby causing the fluid to flow through the orifice.

### BRIEF DESCRIPTION OF THE DRAWINGS

FIG. 1 depicts E-Craft 100 in the prior art.

FIG. 2 depicts, via sequential illustration, ramp 102 unfolding in conventional fashion.

FIG. 3 depicts a ramp wherein an apron of the ramp is coupled to a damper according to some embodiments of the present invention.

FIG. 4A-1 depicts a first perspective view of the exterior of a damper according to some embodiments of the present invention.

FIG. 4A-2 depicts a second perspective view of the exterior of a damper according to some embodiments of the present invention.

FIG. 4B depicts a cross-sectional view of the damper of FIG. 4A-1.

FIG. 4C depicts a cut-away view of the damper of FIG. 4A-1.

FIG. 4D depicts a sectional side view of the damper of FIG. 4A-1.

FIG. 4E depicts detail of an orifice within the damper of FIG. 4A-1.

FIG. 5A depicts a detail of the sectional side view of FIG. 4D with a contracted thermal compensator.

FIG. 5B depicts a detail of the sectional side view of FIG. 4D with a partially elongated thermal compensator.

FIG. 5C depicts a detail of the sectional side view of FIG. 4D with a thermal compensator whose location has been adjusted via a position adjustor.

FIG. 6A depicts a first exploded perspective view of the damper of FIG. 4A-1.

FIG. 6B depicts a second exploded perspective view of the damper of FIG. 4A-2.

FIG. 7 presents method 700 in accordance with an illustrative embodiment of the present invention.

FIG. 8 depicts sub-operation 802 of operation 702.

FIG. 9 depicts sub-operation 904 of operation 704.

FIG. 10 presents method 1000 in accordance with an illustrative embodiment of the present invention.

### DETAILED DESCRIPTION

The following terms are defined for use in this disclosure and in the accompanying claims:
“Fluidically coupled” means that liquid, gas, or vapor from a first region can flow to or otherwise cause an effect in a second region. For example, if two regions are fluidically coupled, a pressure change in one of those regions might (but not necessarily will) result in a pressure change in the other of the regions.
“Operatively coupled” means that the operation of one element or device affects another device, wherein the devices need not be physically coupled. For example, a laser and a mirror are operatively coupled if a laser directs a beam of light to the mirror.
“Physically connected” or “physically coupled” means in direct physical contact and affixed (e.g., a mirror that is mounted on a linear motor).

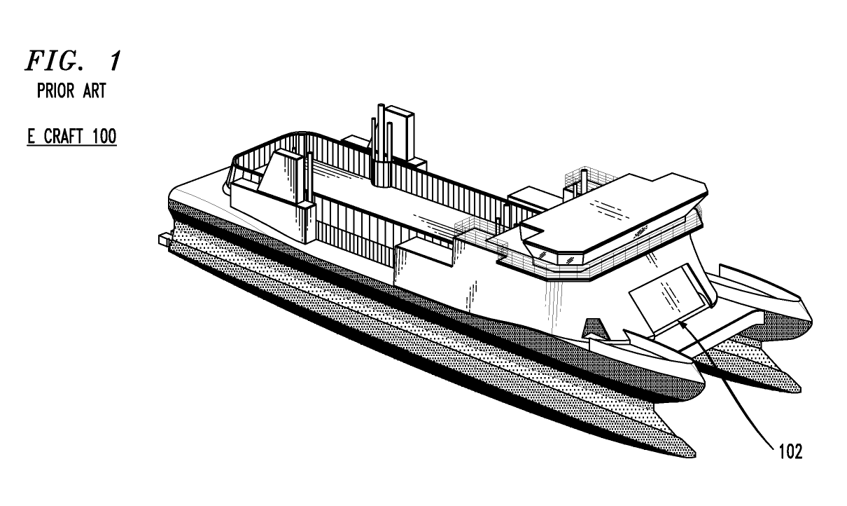

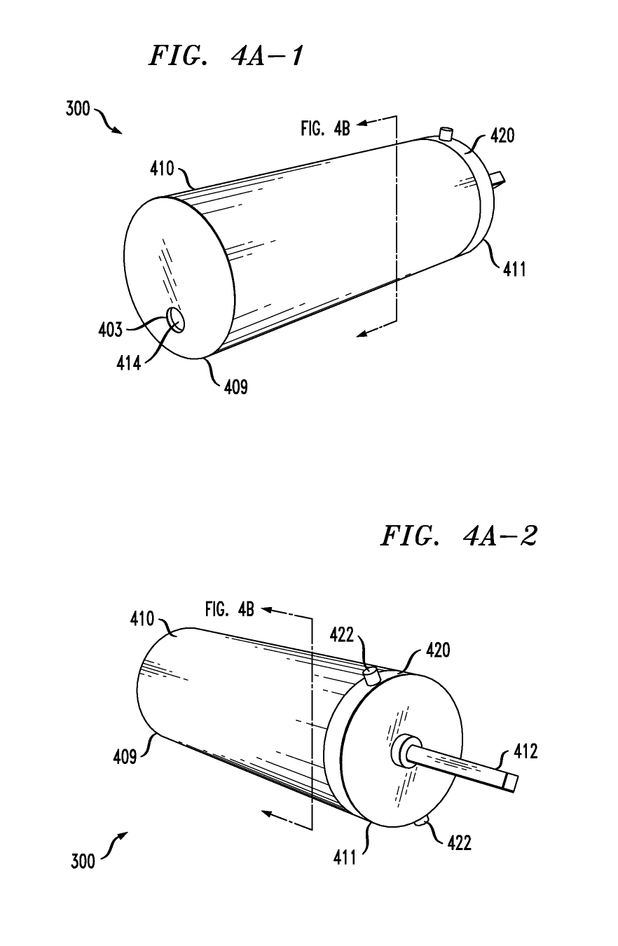

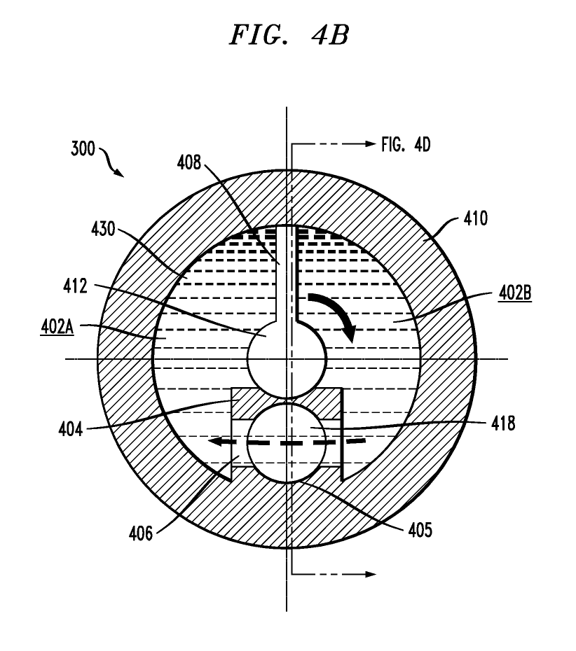

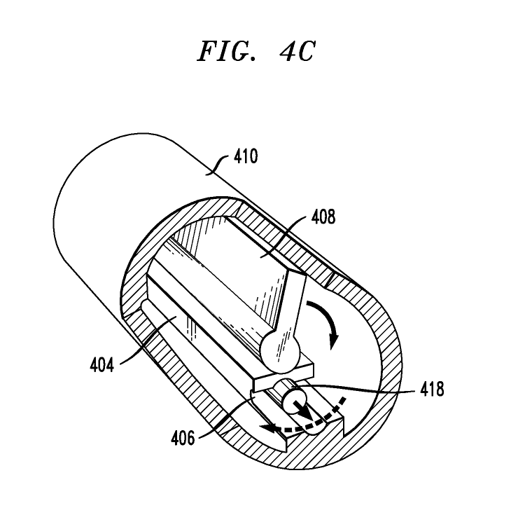

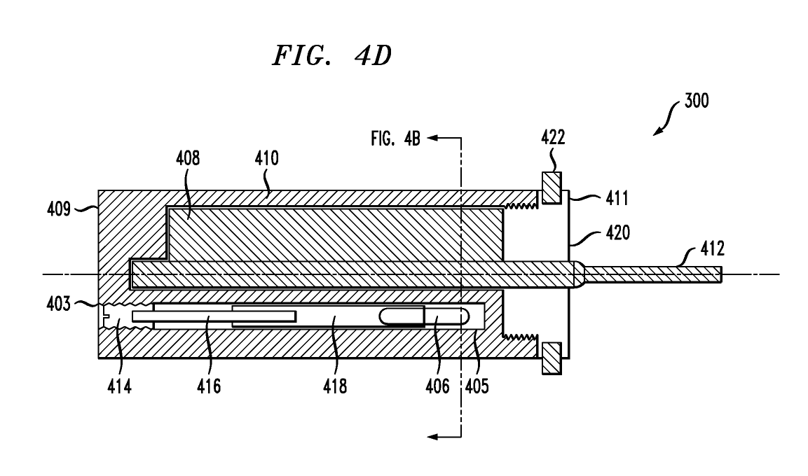

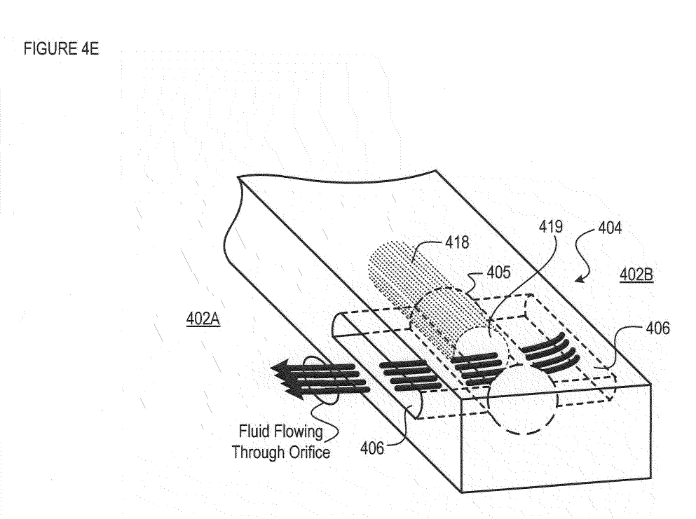

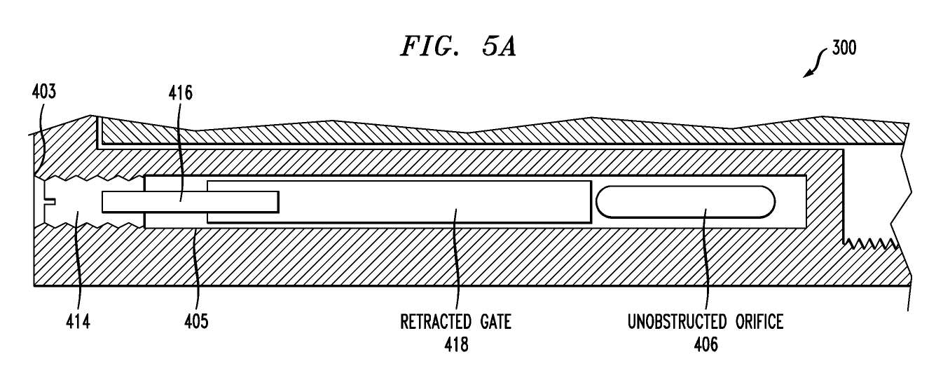

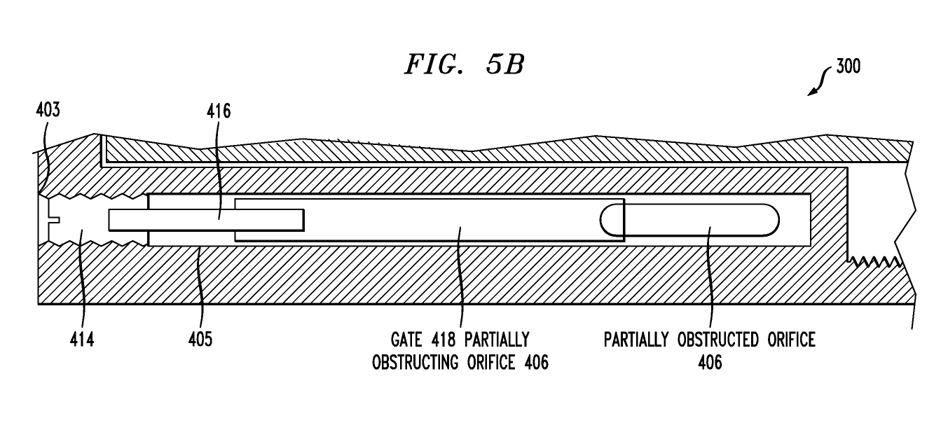

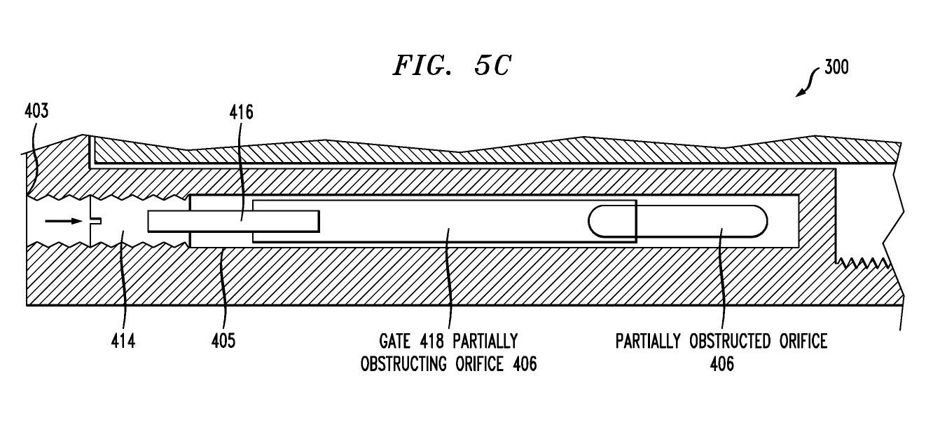

Key Elements of the Illustrative Embodiment. The damper according to the illustrative embodiment relies on several key elements. These elements include:
An orifice that enables hydraulic fluid to flow between two chambers inside the damper. The rotational speed available from the damper depends on the rate of flow through the orifice. The orifice is depicted in FIGS. 4B through 4D and 5A through 5C and is discussed further in the accompanying description.
The damper is sealed to contain the fluid within the two chambers, which have no outlet except for the orifice. This is illustrated in FIGS. 4B and 4C and is discussed further in the accompanying description.
A thermal compensator, which is disposed within the damper, responds to ambient temperature to cause a change in the size of the orifice. The thermal compensator is depicted in FIGS. 4D, 5A through 5C, and 6A and is discussed further in the accompanying description.
A position adjustor, accessible from outside the damper, enables an operator to alter the position of the temperature compensator with respect to the orifice while the damper remains installed. This change in position affects orifice size, thereby impacting the rotational speed available from the damper. In the illustrative embodiment, the position adjustor is an adjusting screw, which is manually turned. The position adjustor is depicted in FIGS. 4A-1, 4D, 5A through 5C, and 6A and is discussed further in the accompanying description.
The use of a thermal compensator and a position adjustor provides independent mechanisms for affecting the rotational speed available from the damper. This combination improves the operability of the damper relative to the prior art over a wide range of operating conditions. This is discussed in conjunction with FIGS. 5A through 5C.

Turning now to the figures, it is to be understood that some structures and devices that are well-known in the art are not depicted in detail in the accompanying figures to maintain focus on the elements that are germane to understanding the present invention. It should be further understood that the figures describing the present invention are not to scale. Any mismatches among the components illustrated herein are understood to be rendering errors or approximations, and do not reflect on the integrity of the present invention.

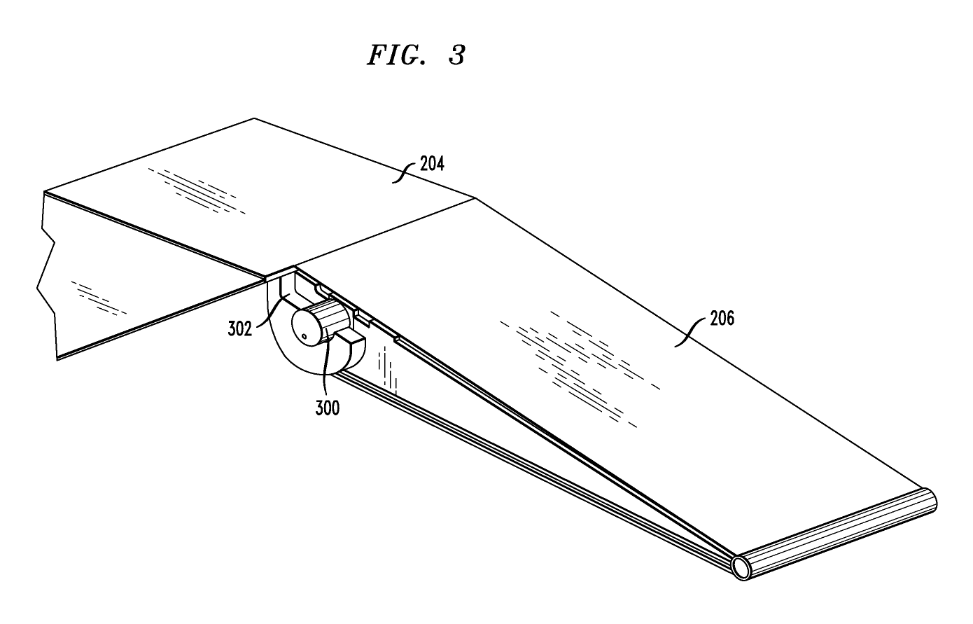

FIG. 3 depicts a portion of a multi-stage ramp, showing stage 204 and apron 206. Stage 204 and apron 206 are well-known elements of a conventional multi-stage ramp. Apron 206 is rotatably coupled to stage 204 via damper 300, which performs the functions described herein in reference to the present invention.

Apron 206 rotates about the longitudinal axis of damper 300. The rotational speed of apron 206 is controlled by damper 300 as described in more detail below.

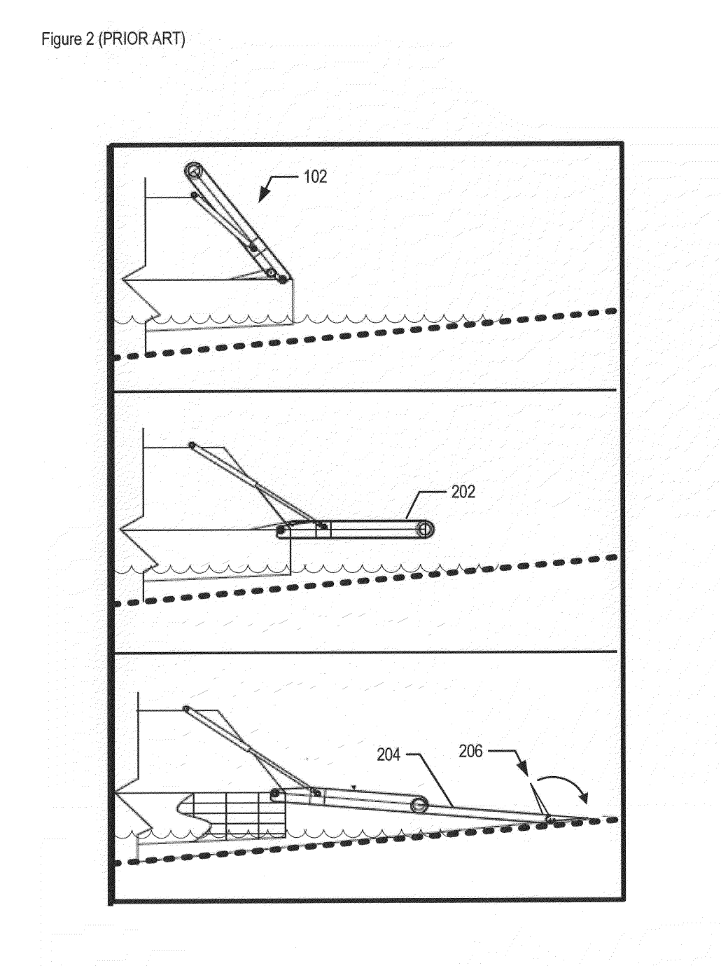

According to the illustrative embodiment, brackets 302 (only one such bracket is shown; the other bracket 302 is on the hidden side of the ramp) are affixed to stage 204. Brackets 304 (not shown in the present figure; the other bracket 304 is on the hidden side of the ramp) are also affixed to stage 204. Each bracket 302 is coupled to its companion bracket 304. Together, bracket 302 and bracket 304, when coupled to each other, form a kind of ring that accommodates and supports damper 300. Damper 300 engages to at least one of bracket 302 and bracket 304 via pins 422 (shown in FIG. 4A-2). Apron 206 couples to damper 300 via shaft 412 (shown in FIG. 4A-2). In this way, damper 300 acts as a rotational axle for apron 206, enabling apron 206 to rotatably couple to stage 204. It will be clear to those having ordinary skill in the art, after reading the present disclosure, how to make and use alternative brackets or bracket assemblies capable of supporting and engaging damper 300 while permitting apron 206 to rotate relative to stage 204.

FIGS. 4A-1 and 4A-2 depict two perspective views of the exterior of damper 300 according to some embodiments of the present invention. Features of damper 300 depicted in these figures include access hole 403, position adjustor 414, housing 410, cap 420, pins 422, and shaft 412.

Housing 410, having end 409 and end 411, provides a cylindrical exterior for damper 300 according to the illustrative embodiment. It is to be understood that in alternative embodiments, housing 410 is not cylindrical, but is, for example, a rectangular prism. Cap 420 is a releasable portion of housing 410 that is described in more detail in later figures.

Shaft 412 runs along a longitudinal axis of damper 300. A portion of shaft 412 extends beyond housing 410 to engage apron 206 so that the apron moves in concert with the shaft. It is to be understood that the shaft size depends on the load that is to be applied by apron 406.

Position adjustor 414 is situated within a cylindrical cavity or bore (see bore 405 in FIGS. 4B-4E, etc.) and is accessible from the exterior of damper 300 via access hole 403 at end 409 of housing 410. In the illustrative embodiment, position adjustor 414 is a screw, which is manually turned. As such, access to position adjustor 414 must be provided. In the illustrative embodiment, access to the position adjustor is via access hole 403.

In some other embodiments, position adjustor 414 is actuated/powered electrically, pneumatically, hydraulically, etc. In such embodiments, position adjustor 414 can be actuated by, for example, pressing a button, flipping a switch, remote control, etc., such that access hole 403 is not required. It will be clear to those having ordinary skill in the art, after reading the present disclosure, how to make and use alternative designs of damper 300 wherein the position adjustor is powered, as indicated above, and “access” is provided indirectly via electronics, wireless communication, etc. Position adjustor 414 is discussed in further detail later in this specification.

Pins 422 couple housing 410 to brackets 302/304 or to any other bracket or bracket assembly that supports and accommodates damper 300.

FIGS. 4B-4E. FIG. 4B depicts an end-on sectional view of damper 300; FIG. 4C depicts a cut away view of damper 300; FIG. 4D depicts a side sectional view of damper 300; and FIG. 4E depicts additional detail of flow-control block 404 of damper 300.

Referring now to FIGS. 4B through 4E, damper 300 comprises chambers 402A and 402B (see FIG. 4B), flow-control block 404, bore 405, orifice 406, blade 408, housing 410, shaft 412, gate 418, and fluid 430. It is to be understood that for the sake of simplicity a number of seals and other components of damper 300 are not illustrated in the present figures; they are depicted and discussed in later figures.

Housing 410 is sealed to contain fluid 430. As depicted in FIG. 4B, chambers 402A and 402B are defined and separated by blade 408, which, as previously noted, is attached to shaft 412. Fluid 430 fills chambers 402A and 402B. Fluid 430 flows between chamber 402A and chamber 402B through orifice 406. Because housing 410 is sealed, fluid 430 can only flow from one chamber to the other through orifice 406. Blade 408 is shown rotating clockwise and causing a clockwise flow through orifice 406 (see also FIG. 4E).

In the illustrative embodiment, fluid 430 is a commercially available hydraulic fluid that is capable of operating under pressure to transmit loads. Such a fluid has limited compressibility and good lubricating properties. Fluid 430 is of a kind that is approved by the Society of Automotive Engineers (“SAE”) and the National Fluid Power Society (“NFPS”). The operational temperature range for the E-craft ramp sub-system is between −34.4° C. and +29.4° C. (−30° F. and +85° F., respectively). It is to be understood that other embodiments of damper 300 as applied to other solutions and configurations (e.g., a tailgate, an E-Craft for a different target environment) have a different operational temperature range. Fluid 430 is selected such that its dynamic viscosity properties are known for the operational temperature range. Ideally, the dynamic viscosity of the selected fluid will be, to the extent possible, linearly proportional to the temperature across the operational temperature range. An exemplary embodiment of the present invention, designed to an operational temperature range of 0° C. to 40° C. (32° F. and 104° F., respectively) has one damper installed per apron panel. For an apron rotation of 90 degrees in 5 seconds, the exemplary embodiment uses an ISO 22 low-temperature hydraulic fluid. One example of a suitable fluid is the Shell Tellus Oil 22 Type HM. It will be clear to those having ordinary skill in the art, after reading the present disclosure, how to perform the necessary analysis to select a hydraulic fluid that is suitable to the implementation and application for which damper 300 is being constructed.

As illustrated in FIGS. 4C and 4D, flow-control block 404 is disposed within housing 410 and extends most of its length and is parallel to the longitudinal axis thereof. As illustrated in FIGS. 4B, 4C, and 4E, flow-control block 404 includes bore 405.

Orifice 406 is disposed in flow-control block 404 proximal to end 411 of housing 410. The orifice is a passage that intersects bore 405. One end of that passage is at a boundary of chamber 402A and the other end of that passage is at a boundary of chamber 402B (see FIG. 4B). Thus, as previously indicated, orifice 406 fluidically couples chamber 402A and chamber 402B and controls the flow of fluid therebetween.

Within bore 405, and linearly arranged with respect to one another are, beginning from end 409 of the housing, position adjustor 414, thermal compensator 416, and gate 418. In some embodiments, a lubricating fluid (not shown) is present in bore 405 to facilitate the movement of the components housed therein.

As previously discussed, position adjustor 414 is accessible through access hole 403 in housing 410. Position adjustor 414 is affixed to one end of thermal compensator 416. The position adjustor functions to alter the position, within bore 405 and relative to orifice 406, of the thermal compensator. In the illustrative embodiment, position adjustor 414 is a screw having an ANSI standard fine thread (UNF). The end of bore 405 proximal to access hole 403 is threaded to receive the screw (or includes a threaded insert).

Thermal compensator 416 comprises a material that, in preferred embodiments, has a coefficient of thermal expansion that is constant across the operational temperature range of damper 300. In regards to the exemplary fluid 430 for an operational temperature range of 0° C. to 40° C. that was discussed above, the corresponding coefficient of thermal expansion for thermal compensator 416 is 66.78×10⁻⁶ m./m.-° C. (37.1×10⁻⁶ in./in.-° F.). An exemplary embodiment with a close fit to this calculated coefficient of thermal expansion is a polycarbonate thermal compensator having a coefficient of thermal expansion of 70.20×10⁻⁶ m./m.-° C. (39.0×10⁻⁶ in./in.-° F.). Another exemplary embodiment is a polystyrene thermal compensator having a coefficient of thermal expansion of 70.02×10⁻⁶ m./m.-° C. (38.9×10⁻⁶ in./in.-° F.). It will be clear to those having ordinary skill in the art, after reading the present disclosure, how to perform the necessary analysis to select a material for thermal compensator 416 that is suitable to the implementation and application for which damper 300 is being constructed.

Gate 418 is affixed to thermal compensator 416. The gate can comprise any material that resists deterioration, corrosion, etc., by fluid 430, and has a low coefficient of thermal expansion such that over the operational temperature range, little expansion/contraction of gate 418 occurs.

In operation, when the ramp is being deployed and apron 206 (FIG. 3) is rotating past vertical to “fall” towards the ground, shaft 412 and affixed blade 408 of damper 300 will likewise rotate. As the blade rotates, it pushes on fluid 430 in one of the chambers 402A or 402B (depending on the orientation of the damper), thereby causing the fluid to flow through orifice 406 to the other chamber.

The presence of orifice 406 affects the movement of fluid 430 between the chambers. To the extent that the movement of fluid is slowed, the fluid resists blade 408, thereby damping its rotation. Since shaft 412 is connected to blade 408, its rotation, as well as the rotation of any article that is coupled to shaft 412 outside of housing 410 (such as apron 206), will also experience damping.

The extent of damping provided by damper 300 depends, at least in part, on the size of orifice 406. As the orifice size (i.e., cross-sectional area for fluid flow) decreases, drag on fluid 430 increases, slowing movement of blade 408 and thereby increasing the amount of damping. The effects of fluid viscosity are discussed later below.

In the illustrative embodiment, the size of orifice 406 is controlled by the position of gate 418. As previously indicated, gate 418 is disposed in bore 405. In operation, gate 418 partially obstructs orifice 406, reducing the cross-sectional area for flow through the orifice (see, e.g., FIGS. 4D and 4E). The extent to which gate 418 obstructs orifice 406 depends on the initial position of thermal compensator 416 within bore 405 (as controlled by position adjustor 414) and the amount that the thermal compensator elongates/contracts in response to the ambient temperature.

When orifice 406 is unobstructed and is at its maximum size, the rotational speed available from damper 300 is at its maximum. Conversely, as more of the orifice is obstructed by gate 418, the rotational speed available from damper 300 decreases.

It will be clear to those having ordinary skill in the art, after reading the present disclosure, how to apply well-known fluid and mechanical design principles to achieve a working balance among the thermal expansion coefficient of thermal compensator 416, the change in fluid dynamic viscosity of fluid 430, and the dimensions of orifice 406 such that the working balance will satisfy the operational needs and performance goals of damper 300.

FIGS. 5A-5C, which are side sectional views of flow-control block 404, illustrate the operation of position adjustor 414, thermal compensator 416, and gate 418 in terms of controlling orifice size and, hence, the amount of damping available from damper 300.

FIG. 5A depicts position adjustor 414 in a nominal position. Thermal compensator 416 is depicted in a state in which it exhibits its minimum size, such as the size at the lowest temperature in its operating temperature range. By virtue of the nominal position of the position adjustor, which, in turn, dictates the position within bore 405 of the thermal compensator and gate 418, orifice 406 is fully unobstructed.

FIG. 5B depicts the arrangement of FIG. 5A when the ambient temperature increases. In particular, position adjustor 414 is in the nominal position as per FIG. 5A. But due to the increase in temperature, thermal compensator 416 has elongated, which advances gate 418 through bore 405 into a position in which it partially obstructs orifice 406. This has reduced the effective size of orifice 406 relative to its size in FIG. 5A.

Consider the change in state of the damper between FIG. 5A and FIG. 5B. In some embodiments, FIG. 5A represents the state of the damper when operating at its minimum operating temperature. At this relatively lower temperature, fluid 430 is relatively more viscous, thereby presenting more resistance to the movement of blade 408. At this temperature, and based on this particular design, orifice 406 is at its maximum size to provide a desired rotational speed from damper 300.

FIG. 5B can represent the state of the damper when operating at some relatively elevated temperature within the operating range. At this relatively higher temperature (compared to the state of the damper in FIG. 5A), fluid 430 is relatively less viscous, thereby presenting relatively less resistance to the movement of blade 408. In the absence of thermal compensation, the rotational speed available from damper 300 would therefore increase. But in accordance with the present invention, thermal compensator 416 elongates when exposed to the relatively elevated temperature. This advances gate 418 through bore 405 to the point where it partially obstructs orifice 406. Reducing the size of the orifice, relative to the state depicted in FIG. 5A, increases the resistance to fluid flow and slows the movement of blade 408. The reduction in orifice size offsets the decrease in fluid viscosity such that the rotational speed that is available from damper 300 remains relatively unchanged, i.e., substantially constant, across the operational temperature range.

FIG. 5C depicts damper 300 in a state in which the position of thermal compensator 416 and gate 418 is advanced through bore 405 via the operation of position adjustor 414. In particular, in this embodiment in which the position adjustor is a screw, the screw is turned to advance all the aforementioned components in bore 405. This advances gate 418 through bore 405 to the point where it partially obstructs orifice 406. Reducing the size of the orifice, relative to the state depicted in FIG. 5A, increases the resistance to fluid flow and slows the movement of blade 408.

The scenario depicted in FIG. 5C can depict embodiments in which the damper is designed such that orifice 406 is partially obstructed for all temperatures in its operating range. Thus, if the ambient temperature drops below the normal operating range, the orifice can be further enlarged by partially withdrawing position adjustor 414. In other words, to the extent that the damper is designed so that the orifice is at maximum size at a given temperature, the damper cannot be adjusted to operate below that temperature (since orifice size cannot be further enlarged). As a consequence, in some embodiments, damper 300 is designed so that orifice 406 is partially obstructed in any and all possible operating (temperature) conditions.

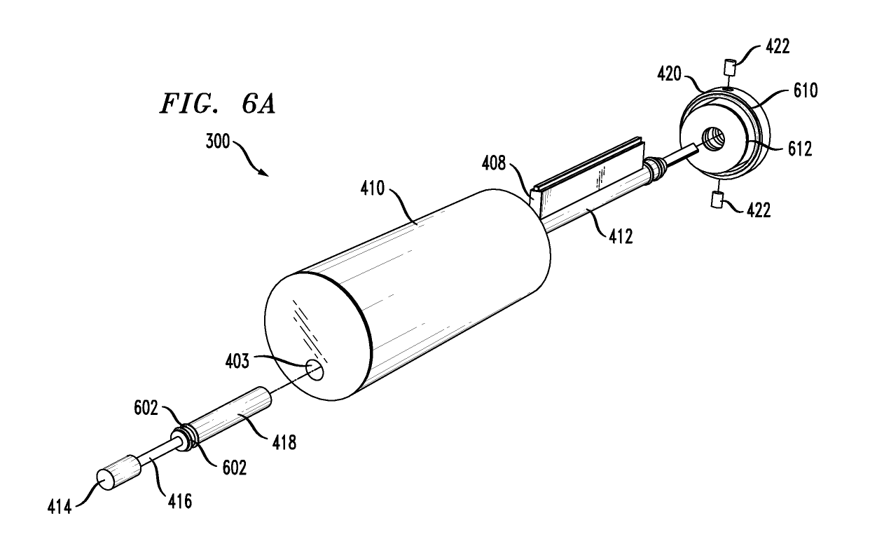

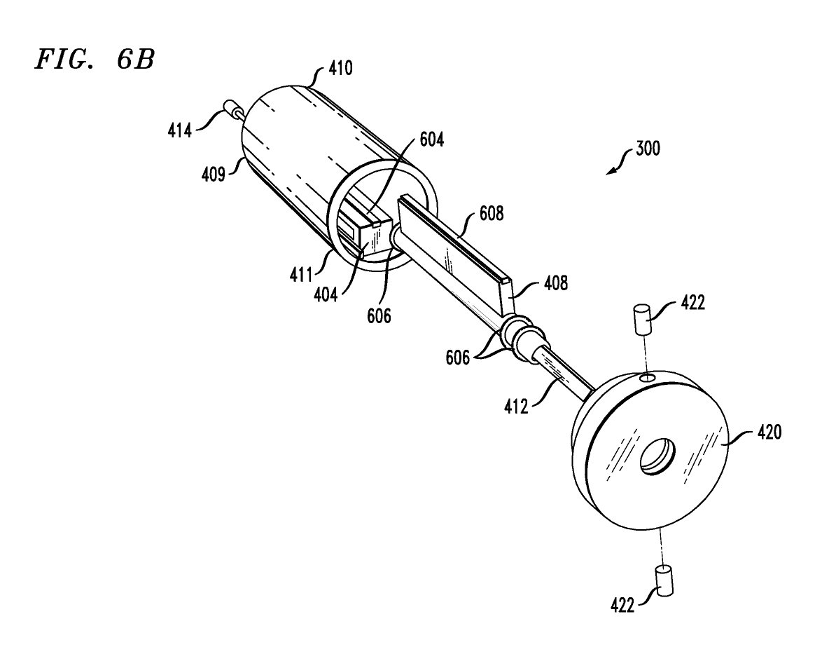

FIGS. 6A and 6B depict exploded perspective views of damper 300. FIG. 6A depicts the components that are linearly arranged in bore 405; namely, position adjustor 414, thermal compensator 416, and gate 418. Sealing rings 602 are o-rings, well-known in the art, which seal gate 418 with respect to bore 405. FIG. 6A also depicts shaft 412 and affixed blade 408, which are disposed in housing 410. FIG. 6A further depicts sealing ring 610. Sealing ring 610 is an o-ring, well-known in the art, which seals cap 420 to the remainder of housing 410, and aids in keeping fluid 430 sealed within housing 410 of damper 300.

FIG. 6B depicts a view into housing 410, showing a portion of flow-control block 404 and the region above it that receives shaft 412 and blade 408. Recess 604 is formed on the top of flow-control block 404 to receive shaft 412. A sealing strip, not depicted, is disposed in recess 604 and provides a seal between shaft 412 and flow-control block 404. This helps to seal chambers 402A and 402B from one another.

Blade 408 is flanked by o-rings 606, which are situated on shaft 412. Near end 409, o-ring 606 seals shaft 412 to the interior of housing 410; near end 411, o-rings 606 seal the shaft against cap 420. The o-rings aid in keeping fluid 430 sealed within housing 410 of damper 300. In alternative embodiments, other approaches for sealing housing 410 against leakage of fluid, as will occur to those skilled in the art, can suitably be used.

Sealing strip 608 is disposed on the edge of blade 408. The sealing strip, which is well known in the art, provides a seal between blade 408 and the interior surface of housing 410. This enables blade 408 to seal chambers 402A and 402B from one another. The various seals (e.g., the seal disposed in recess 604, o-rings 606, sealing strip 608, sealing ring 610) ensure that none of fluid 430 leaks from housing 410 and that all of fluid 430 moving through the housing passes through orifice 406.

FIGS. 6A and 6B also depict cap 420, pins 422, and threaded closure 612. Cap 420 is a releasable portion of housing 410 that acts as a closure for housing 410. In the illustrative embodiment, cap 420 comprises threads 612 that are well-known in the art and engage complementary threads (not depicted) on the interior surface of housing 410. It is to be understood that other releasable closures are possible in alternative embodiments.

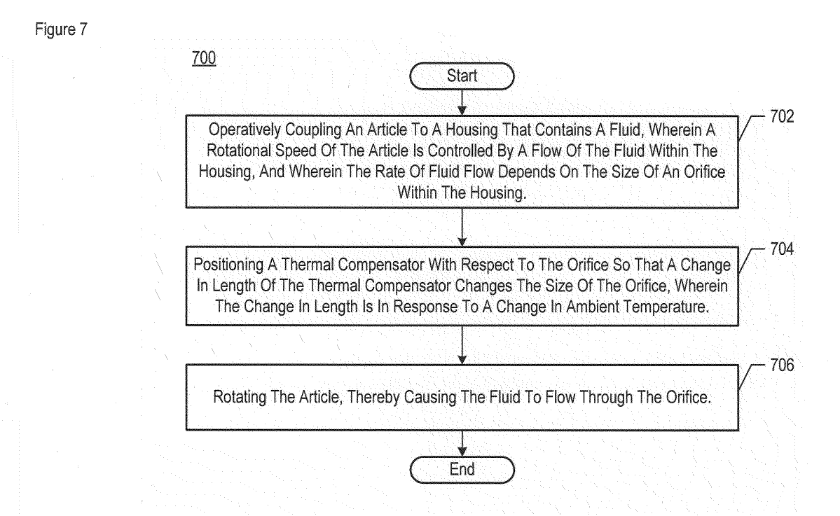

FIG. 7 presents method 700 in accordance with an illustrative embodiment of the present invention.

Operation 702 recites operatively coupling an article to a housing containing a fluid, wherein a rotational speed of the article is controlled by a flow of the fluid within the housing, and wherein the rate of fluid flow depends on the size of an orifice within the housing. In the illustrative embodiment, the article that is operatively coupled to the housing is apron 206.

Operation 704 recites positioning a thermal compensator with respect to an orifice so that a change in length of the thermal compensator, as caused by a change in ambient temperature, changes the size of the orifice.

Operation 706 recites rotating the article, thereby causing the fluid to flow through the orifice. In the illustrative embodiment, this operation entails rotating apron 206 until it is just beyond vertical, such that continuing movement of the apron is due to gravity. It is during the gravitationally induced drop of the apron that damping action provided by damper 300 slows the rotation of the apron.

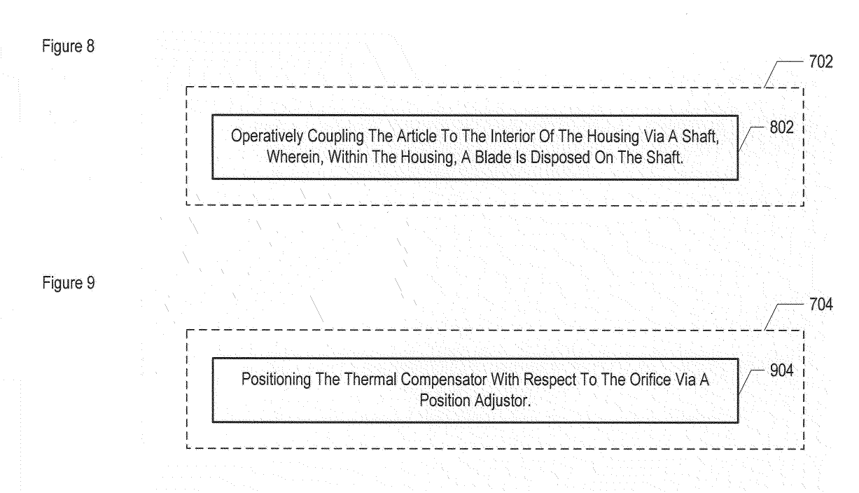

FIG. 8 depicts sub-operation 802 of operation 702. Sub-operation 802 recites that the operation of operatively coupling the article to the housing comprises operatively coupling the article to the interior of the housing via a shaft, wherein, within the housing, a blade is disposed on the shaft.

FIG. 9 depicts sub-operation 904 of operation 704. Sub-operation 904 recites that the operation of positioning the thermal compensator comprises the use of a position adjustor. In the illustrative embodiment, position adjustor 414 is a screw.

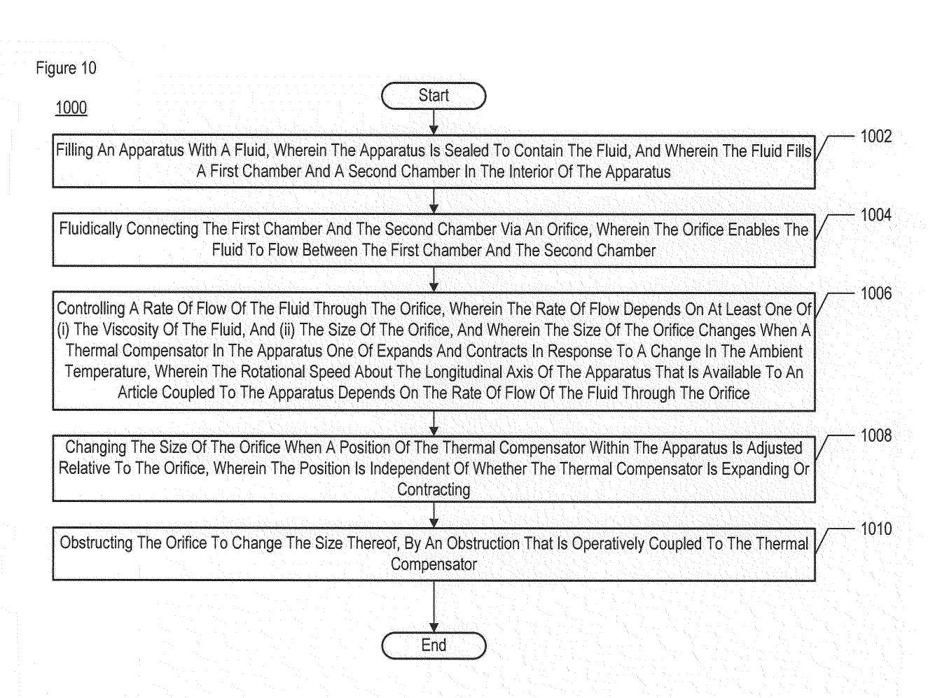

FIG. 10 presents method 1000 for controlling a rotational speed about a longitudinal axis of an apparatus, in accordance with an illustrative embodiment of the present invention.

Operation 1002 recites filling an apparatus with a fluid, wherein the apparatus is sealed to contain the fluid, and wherein the fluid fills a first chamber and a second chamber in the interior of the apparatus. In the illustrative embodiment, the apparatus is damper 300, which is filled with fluid 430.

Operation 1004 recites fluidically connecting the first chamber and the second chamber via an orifice, wherein the orifice enables the fluid to flow between the first chamber and the second chamber. This operation recites the fluidic connection between the interior chambers of damper 300 that enables fluid 430 to flow from one chamber to the other.

Operation 1006 recites controlling a rate of flow of the fluid through the orifice, wherein the rate of flow depends on at least one of (i) the viscosity of the fluid, and (ii) the size of the orifice, and wherein the size of the orifice changes when a thermal compensator in the apparatus one of expands and contracts in response to a change in the ambient temperature. Accordingly, the rotational speed about the longitudinal axis of the apparatus that is available to an article coupled to the apparatus depends on the rate of flow of the fluid through the orifice.

Operation 1008 recites changing the size of the orifice when a position of the thermal compensator within the apparatus is adjusted relative to the orifice, wherein the position is independent of whether the thermal compensator is expanding or contracting. The thermal compensator in the illustrative embodiment is thermal compensator 416, which linearly expands (elongates) and contracts in response to changes in ambient temperature.

Operation 1010 recites obstructing the orifice to change the size thereof, by an obstruction that is operatively coupled to the thermal compensator. In the illustrative embodiment, gate 418 is the obstruction.

It is to be understood that the above-recited operations can be performed in a different order, in different subsets, or in combinations. It is to be further understood that these operations can be achieved by alternative embodiments that feature different implementations of the present invention.

It will be clear to those having ordinary skill in the art, after reading the present disclosure, how to make and use alternative designs of the components depicted herein that perform the functions illustrated by the present figures, including, for example alternative designs with different numbers of components; with different placement of parts relative to each other; with different dimensions; with different materials; with different temperature ranges, etc. It is to be understood that the present disclosure teaches just one example of the illustrative embodiment and that many variations of the invention can easily be devised by those skilled in the art after reading this disclosure and that the scope of the present invention is to be determined by the following claims.

1. An apparatus comprising a damper, wherein the damper comprises:
a thermal compensator that, in response to a change in the ambient temperature, one of expands and contracts;
a blade that defines a first chamber and a second chamber within a housing of the damper;
an orifice between the first chamber and the second chamber, wherein the orifice is operatively coupled to the thermal compensator such that the orifice (i) decreases when the thermal compensator expands and (ii) increases when the thermal compensator contracts; and
a fluid that fills the first chamber and the second chamber, wherein the fluid flows through the orifice when the blade rotates about a longitudinal axis of the apparatus, and wherein the rate of flow of the fluid depends on the size of the orifice.

2. The damper of claim 1 wherein (i) when the thermal compensator expands, an obstruction obstructs the orifice to decrease the size thereof, and (ii) when the thermal compensator contracts, the obstruction retracts to increase the size of the orifice.

3. The damper of claim 2 wherein the obstruction is a gate that is operatively coupled to the thermal compensator.

4. The damper of claim 2 wherein the obstruction further operates in response to a position of the thermal compensator within the damper.

5. The damper of claim 4 wherein the position of the thermal compensator is established by a position adjustor that is operatively coupled to the thermal compensator and that is accessible from the exterior of the damper.

6. The apparatus of claim 1 wherein the damper comprises a housing that is sealed to contain the fluid within the housing.

7. The apparatus of claim 1 wherein the apparatus is at least one of a ramp and a tailgate.

8. An apparatus comprising:
a thermal compensator that has an adjustable position;
a blade that defines a first chamber and a second chamber within the apparatus;
an orifice between the first chamber and the second chamber, wherein the orifice is operatively coupled to the thermal compensator such that the size of the orifice depends on at least one of (i) the adjustable position of the thermal compensator, (ii) an expansion of the thermal compensator in response to a first change in the ambient temperature, and (iii) a contraction of the thermal compensator in response to a second change in the ambient temperature; and
a fluid that fills the first chamber and the second chamber, wherein the fluid flows through the orifice when the blade rotates about a longitudinal axis of the apparatus, and wherein the apparatus is sealed to contain the fluid.

9. The apparatus of claim 8 wherein the adjustable position of the thermal compensator is adjusted via a position adjustor that is operatively coupled to the thermal compensator and that is accessible from the exterior of the apparatus.

10. The apparatus of claim 8 wherein the adjustable position of the thermal compensator is one of (i) a first position that causes an obstruction to decrease the size of the orifice, and (ii) a second position that causes the obstruction to increase the size of the orifice.

11. The apparatus of claim 10 wherein the obstruction is a gate that is operatively coupled to the thermal compensator.

12. The apparatus of claim 8 wherein a rotational speed, which is available to an article that is coupled to the apparatus and rotates about the longitudinal axis thereof, depends on (i) the viscosity of the fluid and (ii) the size of the orifice.

13. The apparatus of claim 12 wherein the combination of (i) the viscosity of the fluid and (ii) the size of the orifice causes the available rotational speed to remain substantially constant over an operational range of temperatures.

14. An apparatus for damping a rotational speed about a longitudinal axis of the apparatus, the apparatus comprising:
a blade that is affixed to a shaft that is disposed along a longitudinal axis of the apparatus;
a housing that houses the blade and a part of the shaft, wherein the blade separates a first chamber and a second chamber in the housing;
an orifice of changeable size that fluidically connects the first chamber and the second chamber;
a fluid that fills the first chamber and the second chamber, wherein the fluid flows through the orifice between the first chamber and the second chamber when the blade rotates about the longitudinal axis of the apparatus, wherein the housing is sealed to contain the fluid; and
a thermal compensator that is disposed and arranged within the housing to cause the orifice to become at least partially obstructed, wherein the size of the orifice depends on the degree of obstruction.

15. The apparatus of claim 14 wherein the degree of obstruction of the orifice depends on at least one of (i) expanding of the thermal compensator in response to a first change in the ambient temperature, (ii) contracting of the thermal compensator in response to a second change in the ambient temperature, and (iii) positioning of the thermal compensator independently of whether the thermal compensator is expanding or contracting.

16. The apparatus of claim 15 wherein the positioning of the thermal compensator is performed by a position adjustor that is operatively coupled to the thermal compensator and is accessible from the exterior of the housing.

17. The apparatus of claim 14 wherein the thermal compensator is operatively coupled to a gate that obstructs the orifice at least in part to change the size thereof.

18. A method comprising:
operatively coupling an article to a housing that contains a fluid, wherein a rotational speed of the article is controlled by a flow of the fluid within the housing, and wherein the rate of flow of the fluid depends on the size of an orifice within the housing;
positioning a thermal compensator with respect to the orifice such that a change in length of the thermal compensator changes the size of the orifice, wherein the change in length is in response to a change in the ambient temperature; and
rotating the article, thereby causing the fluid to flow through the orifice.

19. The method of claim 18 further comprising:
operatively coupling the article to the interior of the housing via a shaft, wherein, within the housing, a blade is disposed on the shaft.

20. The method of claim 18 further comprising:
positioning the thermal compensator with respect to the orifice via a position adjustor.

21. The method of claim 18 wherein the rate of flow of the fluid further depends on the viscosity of the fluid, and wherein a combination of the viscosity of the fluid and the size of the orifice provides a substantially constant rate of flow through the orifice across an operational temperature range.

22. A method for controlling a rotational speed about a longitudinal axis of an apparatus, the method comprising:
filling the apparatus with a fluid, wherein the apparatus is sealed to contain the fluid, and wherein the fluid fills a first chamber and a second chamber in the interior of the apparatus;
fluidically connecting the first chamber and the second chamber via an orifice, wherein the orifice enables the fluid to flow between the first chamber and the second chamber; and
controlling a rate of flow of the fluid through the orifice, wherein the rate of flow depends on at least one of (i) the viscosity of the fluid, and (ii) the size of the orifice, and wherein the size of the orifice changes when a thermal compensator in the apparatus one of expands and contracts in response to a change in the ambient temperature;
wherein the rotational speed about the longitudinal axis of the apparatus that is available to an article coupled to the apparatus depends on the rate of flow of the fluid through the orifice.

23. The method of claim 22 further comprising:
changing the size of the orifice when a position of the thermal compensator within the apparatus is adjusted relative to the orifice, wherein the position is independent of whether the thermal compensator is expanding or contracting.

24. The method of claim 22 further comprising:
obstructing the orifice to change the size thereof, by an obstruction that is operatively coupled to the thermal compensator.
